(19) United States
(12) Patent Application Publication
(10) Pub. No.: US 2006/0232763 A1
(43) Pub. Date: Oct. 19, 2006

(54) Optical element, measuring apparatus and measuring method

(75) Inventor: Hannu Ensio Jokinen, (US)

Correspondence Address: Leon Nigohosian, Jr.;Specialty Minerals Inc./Minteg International Inc., 1 Highland Avenue, Bethlehem, PA, 18017-9482, US

(73) Assignee: Specialty Minerals (Michigan) Inc.

(21) Appl. No.: 11/106,773

(22) Filed: Apr. 15, 2005

(51) Int. Cl. G01C 3/08

(52) U.S. Cl. 356/5.14; 356/5.1

(57) ABSTRACT

The optical element comprises a beam transformer and at least one non-reciprocal component for propagation-direction-dependent polarization operation such that an entrance aperture of the transmission direction, a common two-directional aperture for an exit in the transmission direction and for an entrance in the reception direction, and an exit aperture of the reception direction can be used in the beam transformer. The beam transformer both transmits an optical beam towards an object and receives the reflected optical beam through the common aperture. The beam transformer outputs the received optical beam through the exit aperture of the reception direction different from the entrance aperture of the transmission direction.

The invention relates to an optical element, a measuring apparatus and a measuring method.

A distance measuring apparatus can be a range finder based on a time-of-flight principle with two separate optical axes, a first axis for transmission and a second axis for reception. A laser of the measuring apparatus transmits an optical beam through the first axis furnished with a suitable optical arrangement towards a desired object and an optical beam reflected from the object is received through the second optical axis furnished with a suitable optical arrangement for receiving. The duration for an optical signal to travel from the measuring apparatus to the object and back can be measured and the measured result can be transformed into distance on the basis of the speed of light. In time-of-flight method, e.g. using pulsed laser beam or amplitude modulated continuous laser beam, a characteristic shape of the signal determines the time point being used in the calculation of the time difference and distance value.

Because of the two separate optical axes, the coverage area of the transmitted beam on the object is different from the coverage area, which is observed through the second axis by the receiver. The difference in the coverage areas results in a loss of optical power in the measurement and in a low signal-to-noise ratio. The structure of the optical system also becomes complicated. For example, two objective lenses are needed, one for transmission and one for reception, which makes the measuring head large. These are particularly serious problems in measuring vessels for hot-steel processing.

To avoid the problems related to the separate optical axes, an arrangement utilizing partially reflecting and transmitting beam splitters have been proposed. In a usual case, the beam splitters may transmit 50 percent and reflect 50 percent. The arrangement combines the optical axes in the transmission and the reception directions for a co-axial operation. There are, however, problems related to this solution, too. These kinds of beam splitters waste optical power when splitting the beam. In the transmission direction, 50 percent at the maximum of optical power can be directed to the object through the co-axial arrangement and 50 percent at the maximum of optical power directed to the object can be received through the co-axial arrangement. Hence, if it is considered that all power of the optical beam transmitted is reflected back, the theoretical maximum performance efficiency is only 25 percent (=50 percent ·50 percent) which typically denotes a worse operation than with the two optical axes. Utilizing a linear polarized source, a polarizing beam splitter may transmit nearly 100 percent of the optical beam, but only 50 percent can be received at the detector and the other 50 percent travels back to the source.

### SUMMARY OF THE INVENTION

An object of the invention is to provide an improved optical element, measuring apparatus and measuring method.

According to an aspect of the invention, there is provided an optical element for a measuring apparatus configured to transmit an optical beam towards an object in a transmission direction through the optical element, and to receive an optical beam reflected from the object in a reception direction through the optical element. The optical element includes a beam transformer having an entrance aperture of the transmission direction, a common two-directional aperture for an exit in the transmission direction and for an entrance in the reception direction, and an exit aperture of the reception direction. The beam transformer is configured to form at least two internal optical channels supporting different plane-polarization directions, at least one of the internal optical channels being common to the transmission and reception direction. There is at least one non-reciprocal component for propagation-direction-dependent polarization operations, and in the transmission direction. The beam transformer is configured to pass the optical beam from the entrance aperture to at least one common optical channel. The at least one non-reciprocal component, one in each common optical channel, is configured to perform a first propagation-direction-dependent operation on the optical beam. The beam transformer is configured to transmit the beam from the at least one common channel through the common aperture; and in the reception direction. The beam transformer is configured to split the beam received through the common aperture into plane-polarized beams and to pass the plane-polarized beams to the internal optical channels.

Each non-reciprocal component is configured to perform a second propagation-direction-dependent operation on the plane-polarized beam in the at least one common optical channel. The beam transformer is configured to combine the plane-polarized beams from the internal optical channels into one received optical beam, and to output the received optical beam through the exit aperture of the reception direction different from the entrance aperture of the transmission direction due to propagation-direction-dependent operations in the at least one common optical channel.

According to another aspect of the invention, there is provided a measuring apparatus, the measuring apparatus configured to transmit an optical beam towards an object in a transmission direction through the optical element, and to receive an optical beam reflected from the object in a reception direction through the optical element. The optical element includes a beam transformer having an entrance aperture of the transmission direction, a common two-directional aperture for an exit in the transmission direction and for an entrance in the reception direction, and an exit aperture of the reception direction. The beam transformer being configured to form at least two internal optical channels supporting different plane-polarization directions, at least one of the internal optical channels being common to the transmission and reception directions. There is at least one non-reciprocal component for propagation-direction-dependent polarization operations, and in the transmission direction. Additionally, the beam transformer is configured to pass the optical beam from the entrance aperture to at least one common optical channel. The at least one non-reciprocal component, one in each common optical channel, is configured to perform a first propagation-direction-dependent operation on the optical beam. The beam transformer is also configured to transmit the beam from the at least one common channel through the common aperture; and in the reception direction. The beam transformer is also configured to split the beam received through the common aperture into plane-polarized beams and to pass the plane-polarized beams to the internal optical channels. Each non-reciprocal component is configured to perform a second propagation-direction-dependent operation on the plane-polarized beam in the at least one common optical channel. Finally, the beam transformer is configured to combine the plane-polarized beams from the internal optical channels into one received optical beam, and to output the received optical beam through the exit aperture of the reception direction different from the entrance aperture of the transmission direction due to propagation-direction-dependent operations in the at least one common optical channel.

According to another aspect of the invention, there is provided a measuring method wherein the method includes transmitting, by a measuring apparatus, an optical beam towards an object in a transmission direction through an optical element. The optical beam is reflected from the object in a reception direction through the optical element, and meaured by the measuring apparatus. Transmitting includes passing, by a beam transformer, the optical beam from an entrance aperture of transmission direction to at least one optical channel common to transmission and reception directions. At least one non-reciprocal component, one in each common optical channel, performs a first propagation-direction-dependent operation on the optical beam. The optical beam is transmitted through a common aperture for the transmission and the reception directions. The receiving includes splitting the beam received through the common aperture into plane-polarized beams, and passing the plane-polarized beams to the internal optical channels by the beam transformer.

Each non-reciprocal component performs a second propagation-direction-dependent operation on the plane-polarized beam in the at least one common optical channel.

The plane-polarized beams from the internal optical channels are combined into one received beam, and outputting the received beam through the exit aperture of the reception direction by the beam transformer, the exit aperture of the reception direction being different from the entrance aperture of the transmission direction due to propagation-direction-dependent operations in the at least one common optical channel.

The invention provides several advantages. The loss of optical power can be minimized and the coverage areas of transmission and reception can be matched completely. A simple optical system can be used resulting in a small measuring head.

### BRIEF DESCRIPTION OF THE FIGURES

In the following, the invention will be described in greater detail with reference to the embodiments and the accompanying drawings, in which

FIG. 1 illustrates an optical element;

FIG. 2 illustrates an optical element with beam transformers,

FIG. 3A illustrates an optical element with beam splitters in operation in a transmission direction,

FIG. 3B illustrates an optical element with beam splitters in operation in a reception direction,

FIG. 4 illustrates a non-reciprocal component,

FIG. 5 illustrates a measuring apparatus,

FIG. 6 illustrates a measuring apparatus with optical fibers,

FIG. 7 illustrates a flow chart of the method in the transmission direction, and

FIG. 8 illustrates a flow chart of the method in the reception direction.

### DETAILED DESCRIPTION OF THE INVENTION

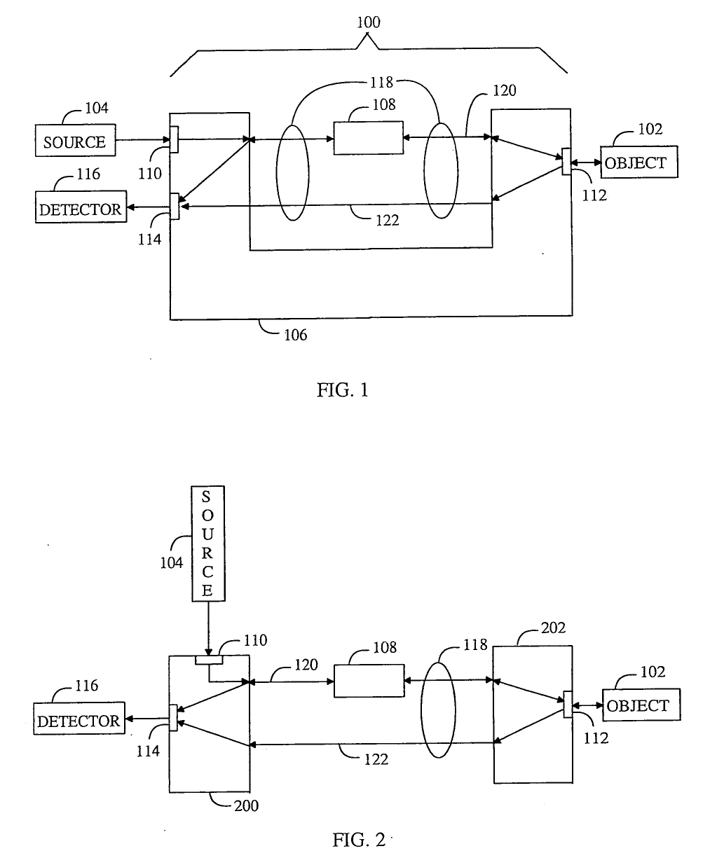

With reference to FIG. 1, an example of an optical element for a measuring apparatus is shown. The optical element 100 can be considered non-reciprocal which, means that the operation of the optical element 100 depends on the optical beam's propagation direction. The measuring apparatus may transmit the optical beam towards an object 102 in a transmission direction through the optical element 100 and the measuring apparatus may receive an optical beam reflected from the object 102 in a reception direction through the optical element 100. In the present application, the optical beam refers to electromagnetic radiation at wavelengths of including, but not limited to, about several hundred nanometers. The transmission direction denotes a direction from an optical source 104 to the object 102 and the reception direction denotes a direction from the object 102 to the optical source 104. The optical source 104 may be a monochromatic optical source such as a laser, a narrow band optical source such as a LED (Light Emitting Diode) or a wideband optical source including, but not limited to, a glow lamp, a gas lamp, a halogen lamp, and the like.

The optical element 100 may comprise a beam transformer 106 and at least one non-reciprocal component 108.

One non-reciprocal component can include a physical component pair like a Faraday rotator and a quarter wave plate.

The beam transformer 106 has an entrance aperture 110 of the transmission direction and a common two-directional aperture 112 for an exit in the transmission direction and for an entrance in the reception direction. The common two-directional aperture 112 for exit and entrance results in co-axial optical operation in the measuring apparatus. The non-reciprocity of the optical element 100 which means in this application a propagation-direction-dependent operation manifests itself such that an entrance aperture 110 of the transmission direction and an exit aperture 114 of the reception direction, which is for outputting the received beam to a stop detector 116, are physically separate.

The propagation-direction-dependent operation can be achieved by at least one non-reciprocal component 108. The operation of the non-reciprocal component 108 may be based on magnetic rotation of a polarization direction of a plane-polarized beam known also as Kundt effect. Hence, the non-reciprocal component 108 may include, for example, a Faraday rotator. Additionally, the measuring apparatus may include a variety of other optical components including, but not limited to, filters, lenses, mirrors, fibers, and the like.

When propagating through the optical element 100 in the transmission direction the beam transformer 106 may form at least two internal optical channels 118 supporting different plane-polarization directions. At least one of the internal optical channels 118 is common to the transmission and reception directions.

The beam transformer 106 may pass the optical beam from the entrance aperture 110 to at least one common optical channel 120, which is common to the transmission and the reception directions.

Each non-reciprocal component 108 performs a first propagation-direction-dependent operation on the optical beam. The number of the non-reciprocal components 108 and the number of the at least one common optical channel 120 is the same, and one common optical channel 120 is provided with one non-reciprocal component 108.

The beam transformer 106 may transmit the optical beam of the transmission direction from the at least one common channel 120 through the common two-directional aperture 112. In measuring apparatus the optical beam is transmitted towards the object 102.

When propagating through the optical element 100 in the reception direction, the beam transformer 106 may split the optical beam received through the common two-directional aperture 112 into plane-polarized beams and passes the plane-polarized beams to the internal optical channels 118. In this propagation direction each non-reciprocal component 108 performs a second propagation-direction-dependent operation on the plane-polarized beam in the at least one common optical channel 120.

The beam transformer 106 combines the plane-polarized beams from the internal optical channels 118 into one received optical beam, and outputs the received optical beam through the exit aperture 114 of the reception direction. The exit aperture 114 of the reception direction is different from the entrance aperture 110 of the transmission direction due to propagation-direction-dependent operations in the at least one common optical channel 120.

The second non-reciprocal operation prevents the optical beam propagating in an common optical channel 120, common to the transmission and the reception directions, from reaching the optical source 104, but instead the optical beam is deviated to the stop detector 116.

Any non-common optical channel 122, i.e. not common to the transmission and the reception directions, does not have a non-reciprocal component 108 and hence the beams propagating in a channel without a non-reciprocal component 108 is guided to the stop detector 116.

The beam transformer 106 may include two polarization transformers as shown in FIG. 2. A first polarization transformer 200 has the entrance aperture 110 of the transmission direction and the exit aperture 114 of the reception direction. A second polarization transformer 202 has the common two-directional aperture 112 for transmission and reception directions.

The polarization transformers 200 and 202 form the at least two internal optical channels 118 supporting different plane-polarization directions between the polarization transformers 200 and 202. The first polarization transformer 200 passes the optical beam from the entrance aperture 110 into the at least one common optical channel 120. The second polarization transformer 202 transmits the optical beam from the at least one common optical channel 120 through the common two-directional aperture 112.

The second polarization transformer 202 splits the optical beam received through the common two-directional aperture 112 into plane-polarized beams, and passes the plane-polarized beams to the at least two internal optical channels 118.

The first polarization transformer 200 combines the plane-polarized beams from the at least two internal optical channels 118 into a received beam, and outputs the received beam through the exit aperture 114 of the reception direction.

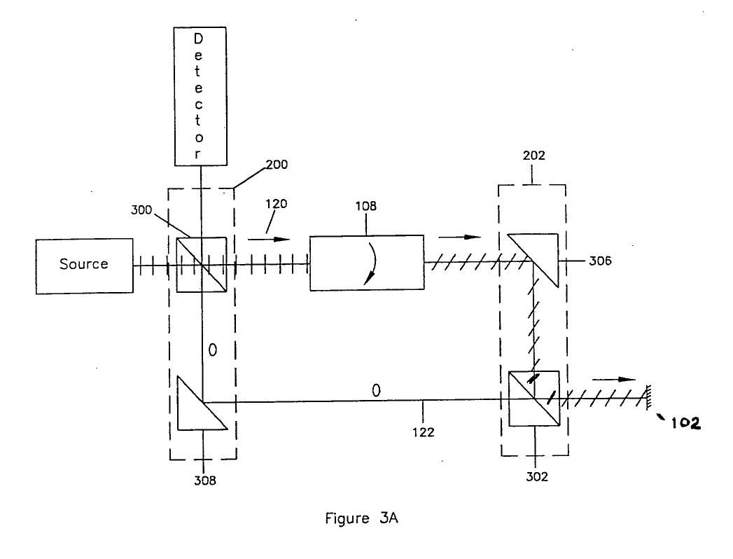

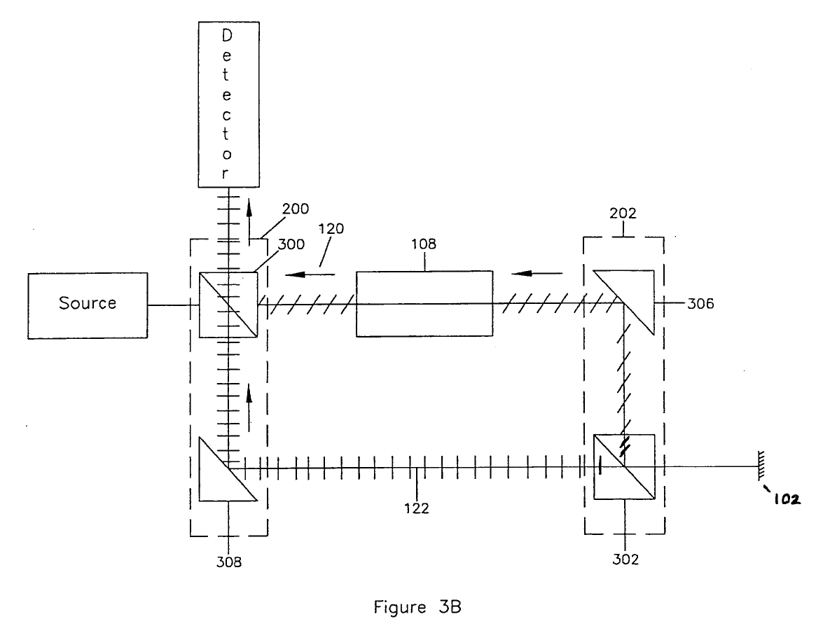

FIGS. 3A and 3B illustrate the optical element 100 utilizing Faraday rotator, quarter wave plate, polarizing beam splitters and mirrors. FIG. 3A represents an example of operation in the transmission direction and FIG. 3B represents a corresponding example of operation in the reception direction. The optical element may include one non-reciprocal component 108 in the common optical channel 120. The other non-common channel 122 has no non-reciprocal component 108.

The first polarization transformer 200 may include an input polarizing beam splitter 300 and an output polarizing beam splitter 302, and the second polarization transformer 202 may include a transceiving polarizing beam splitter 304 and a mirror 306.

When propagating through the optical element in the transmission direction, the input polarizing beam splitter 300 may pass a plane-polarized beam into the common optical channel 120, and pass no beam to the output polarizing beam splitter 302 and to the non-common channel 122. The optical beam entering the input polarizing beam splitter 300 may or may not be plane-polarized. If the optical beam is plane-polarized in the same direction as the input polarizing beam splitter 300, the optical beam passes without loss (in principle) through the input polarizing beam splitter 300. If the polarization directions do not match, at least some loss will be evident. For an optical beam propagating through the input polarizing beam splitter 300, the polarization direction may be vertical as drawn in FIG. 3A.

The non-reciprocal component 108 performs the first propagation-direction-dependent operation on the optical beam in the common optical channel 120.

FIG. 3A illustrates when propagating through the optical element in the reception direction, the transceiving polarizing beam splitter 304 may split the optical beam from the common two-directional aperture 112 into two orthogonally plane-polarized beams, pass a first plane-polarized beam into the common optical channel 120, and pass a second plane-polarized beam to the second mirror 306 configured to reflect the second plane-polarized beam to the input polarizing beam splitter 300 through a second non-common optical channel 122.

The non-reciprocal component 108 may perform the second propagation-direction-dependent operation on the optical beam in the common channel 120. The first propagation-direction-dependent operation and a second propagation-direction-dependent operation may have mutually opposed effects.

The input polarizing beam splitter 300 may pass the first plane-polarized beam to gthe output polarizing beam splitter 302 which may combine the plane-polarized beams from the common optical channels 120 and non-common optical channels 122 into a received optical beam for outputting the received optical beam through the exit aperture 114 of the reception direction.

The combining can be accomplished since the polarization directions of the polarizing beam splitters 300, 302, and 304 are matched with each other. For example, all the beam splitters 300, 302, and 304 may reflect horizontally polarized optical radiation and may be penetrated by vertically polarized optical radiation. The mirror 306 may be a (totally reflecting) surface mirror or a totally reflecting prism.

The configuration shown in FIG. 3C and FIG. 3D provides the same function as FIG. 3A and 3B, but utilizes two beam splitters 300 and 302 and two mirrors 306 and 308 instead of three beam splitters and one mirror. Other configurations are envisioned and are not limited to the examples given above.

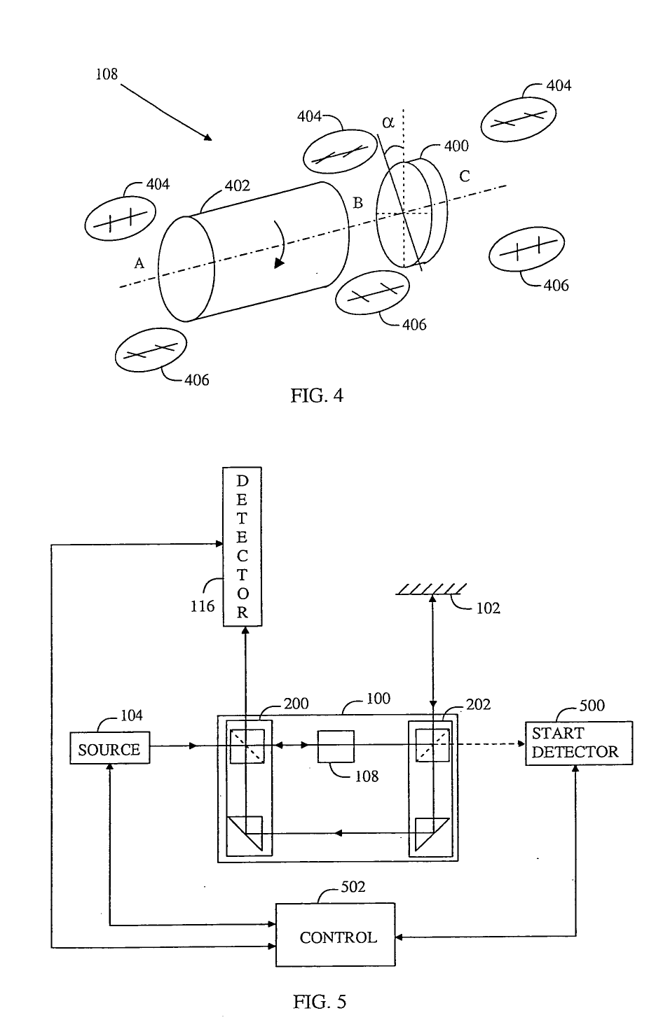

FIG. 4 illustrates an example of a non-reciprocal component 108. The non-reciprocal component 108 may be implemented by combining a quarter-wave component 400 configured to turn a polarization direction by 45 degrees independently of the propagation direction, and a non-reciprocal rotator 402 configured to turn a polarization direction by 45 degrees depending on the propagation direction. Examples 404, 406 of polarization directions before, in and after (locations A, B and C) the non-reciprocal components are shown in FIG. 4. The examples 404 may relate to the transmission direction and the examples 406 may relate to the reception direction or vice versa. The structural order of the quarter-wave component 400 and the non-reciprocal rotator 402 is not important. The quarter-wave component 400 may be a quarter-wave plate made up a birefringent crystal which forms a phase differnce of one-quarter wavelength between the ordinary and the extraordinary rays of the optical beam propagating through the plate. The quarter-wave component 400 should be positioned properly with respect to its lattice directions.

The operation of the non-reciprocal rotator 402 may be based on magnetic rotation of a polarization direction of a plane-polarized beam known also as Kundt effect. When a magnetic field parallel to the propagation direction of the optical beam penetrates a magneto-optic material, the polarization direction of a plane-polarized optical beam rotates in the material. The rotation angle φ of the polarization direction depends, for instance, on magnetic field strength H, distance L the optical beam travels in the magneto-optic material, and a Verdet constant V of the magneto-optic material. The angle φ of rotation can, thus, be defined in a non-constant magnetic field by

$$Φ = V {\int }_{0}^{L} H ( l ) ⅆ l ,$$

where, l is a distance variable and dl is a differential distance. In a constant magnetic field, the equation may simply be written as φ=VHL, i.e. the rotation angle is a product of the Verdet constant V, the constant magnetic field strength H and the thickness of the magneto-optic material L. The rotation direction of the non-reciprocal rotator 400 is shown with an arrow in FIG. 4.

FIG. 5 illustrates a measuring apparatus based on a time-of-flight principle. An optical beam may be transmitted from an optical source 104 to the entrance aperture 110 of the transmission direction in the optical element 100. The optical source 104 may be a mono-chromatic optical source such as a laser, a narrow band optical source such as a LED (Light Emitting Diode) or a wideband optical source including, but not limited to, a glow lamp, an incandescent lamp, a halogen lamp, and the like. The optical beam may travel through the first polarization transformer of the optical element 100 to the second polarization transformer 202, which may penetrate a fraction of the optical beam such that the fraction passes to a start detector 500. The fraction of the optical beam may be due to imperfections in the second transformer and in polarization. Hence, there is no need to construct the second transformer such that it penetrates a certain part of the optical beam although that may also be done. The start detector 500 detects the fraction which may vary from some percentages to a billionth part or less in power, of the beam entering the entrance aperture 110 and feeds a corresponding electrical signal to a control unit 502 which forms a start mark t₁ for the pulse of the optical beam. The start mark t₁ defines the moment relating to the departure of the optical beam from the optical element 100.

The majority of the optical beam is transmitted to the object 102 which reflects a part of the optical beam back to the optical element 100. The received optical beam passes through the optical element 100 to a stop detector 116. The measuring apparatus may be suitable for measuring hot surfaces and objects with high absorption properties without attaching reflectors; e.g. the object 102 may be a hot steel-processing vessel such as a ladle or a converter. The present solution is not, however, restricted to these applications. The stop detector 116 detects the received optical beam and feeds a corresponding electrical signal to a control unit 502 which forms a stop mark t₂ for the pulse of the received optical beam. The stop mark t₂ defines the moment relating to the arrival of the optical beam to the measuring apparatus. The control unit 502 may determine timing difference At Δt=t₂−t₁ of the start mark and the stop mark and the control unit 502 may determine the distance D between the object 102 and the measuring apparatus as a function of the timing difference, D=f(Δt). In a simple model the dependence between the distance D and the timing difference Δt is linear, i.e. D=cΔt, where c is a constant. In the case of the object 102 being a hot steel-processing vessel, the changes in the thickness of the wall of the vessel can be measured as the wall wears, which can be observed in increasing the distance.

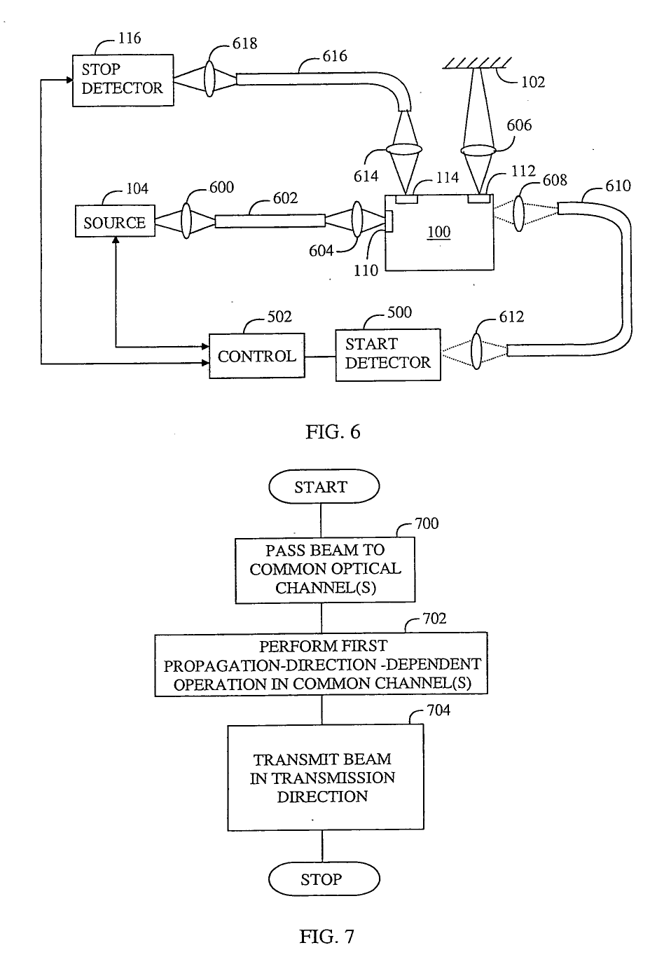

FIG. 6 represents a measuring apparatus utilizing optical fibers. The optical beam from the source 104 may be focused in a transmitting fiber 602 by a first optical unit 600. The optical beam leaving the transmitting fiber 602 may be focused to the entrance aperture 110 of the optical element 100 by a second optical unit 604. The optical beam transmitted from the optical element 100 may be focused or collimated towards the object 102 by a third optical unit 606. The optical beam penetrating towards the start detector 500 may be focused to a start fiber 610 by a fourth optical unit 608. The start pulse propagating out of the start fiber 610 may be focused to the start detector 500 by a fifth optical unit 612. The received optical beam may be focused to a receiving fiber 616 by a sixth optical unit 614. Finally, the received optical beam leaving the receiving fiber 616 may be focused to the stop detector 118 by a seventh optical unit 618. The optical units from the first to the seventh may include at least one lens for focusing or collimating the optical beam. Additionally, any of the optical units may include optical filters for limiting the optical band. A proper optical band may be important in the reception direction particularly.

The measuring apparatus has several advantages because of the optical element 100. The measurement range or the range of optimum signal or the range of maximum signal-to-noise ratio is not limited to common overlapping coverage areas of transmission and reception. The loss of optical power is minimal and theoretically much less than in a conventional measurement. A better measurement accuracy can be acquired than with two-axial measurement. In addition to problems mentioned already, as the distribution of a laser beam is inhomogeneous transversally and longitudinally the effect combined with the variation of target emissivity is extremely difficult to compensate in a two-axial measurement. The present solution avoids the problem completely. Additionally, the present solution also enables the use of telecentric optics, therefore relieving problems related to distance dependent aberrations in transmission and reception.

FIG. 7 illustrates a flow chart of the method relating to a transmission direction. In step 700, the optical beam input through the entrance aperture of transmission direction is split into plane-polarized beams, and passing the plane-polarized beams to internal optical channels by the beam transformer, the internal optical channels being common to the transmission and the reception directions. In step 702, a first propagation-direction-dependent operation is performed on the optical beam by at least two non-reciprocal components, one in each optical channel. In step 704, optical beams from the optical channels are combined into a transmission beam and transmitting the transmission beam through the common aperture, by the beam transformer.

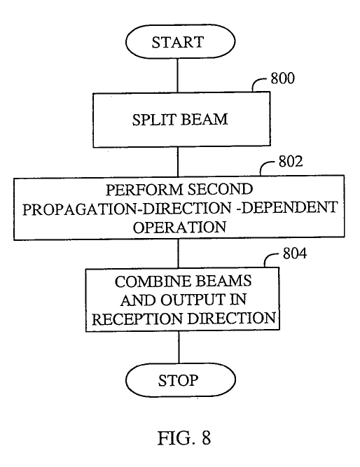

FIG. 8 illustrates a flow chart of method relating to a reception direction. In step 800, the optical beam received through the common aperture is split into plane-polarized beams, and the plane-polarized beams are passed to the optical channels by the beam transformer. In step 802, a second propagation-direction-dependent operation is performed on the plane-polarized beams in the optical channels by each non-reciprocal component. In step 804, the plane-polarized beams are combined from the optical channels into one received beam, and the received beam is output through the exit aperture of the reception direction by the beam transformer, the exit aperture of the reception direction being different from the entrance aperture of the transmission direction due to propagation-direction-dependent operations in the optical channels.

Even though the invention is described above with reference to examples according to the accompanying drawings, it is clear that the invention is not restricted thereto but can be modified in several ways within the scope of the appended claims.

1. An optical element for a measuring apparatus configured to transmit an optical beam towards an object in a transmission direction through the optical element, and to receive an optical beam reflected from the object in a reception direction through the optical element, wherein the optical element comprises:
a beam transformer having an entrance aperture of the transmission direction, a common two-directional aperture for an exit in the transmission direction and for an entrance in the reception direction, and an exit aperture of the reception direction, the beam transformer being configured to form at least two internal optical channels supporting different plane-polarization directions, at least one of the internal optical channels being common to the transmission and reception direction,
at least one non-reciprocal component for propagation-direction-dependent polarization operations, and in the transmission direction,
the beam transformer is configured to pass the optical beam from the entrance aperture to at least one common optical channel,
the at least one non-reciprocal component, one in each common optical channel, is configured to perform a first propagation-direction-dependent operation on the optical beam,
the beam transformer is configured to transmit the beam from the at least one common channel through the common aperture; and in the reception direction.
the beam transformer is configured to split the beam received through the common aperture into plane-polarized beams and to pass the plane-polarized beams to the internal optical channels,
wherein, each non-reciprocal component is configured to perform a second propagation-direction-dependent operation on the plane-polarized beam in the at least one common optical channel, and
the beam transformer is configured to combine the plane-polarized beams from the internal optical channels into one received optical beam, and to output the received optical beam through the exit aperture of the reception direction different from the entrance aperture of the transmission direction due to propagation-direction-dependent operations in the at least one common optical channel.

2. The optical element of claim 1, wherein the beam transformer includes a first polarization transformer and a second polarization transformer, and
the first polarization transformer has the entrance aperture of the transmission direction and the exit aperture of the reception direction;
the second polarization transformer has the common two-directional aperture for transmission and reception directions; and in the transmission direction,
the polarization transformers are configured to form the at least two optical channels supporting different plane-polarization directions between the polarization transformers;
the first polarization transformer is configured to pass the optical beam from the entrance aperture into the at least one common optical channel;
the second polarization transformer is configured to transmit the optical beam from the at least one common optical channel through the common aperture; and in the reception direction,
the second polarization transformer is configured to split the optical beam received through the common aperture into plane-polarized beams, and to pass the plane-polarized beams to the at least two optical channels; and
the first polarization transformer is configured to combine the plane-polarized beams from the at least two optical channels into a received beam, and to output the received beam through the exit aperture of the reception direction.

3. The optical element of claim 1, wherein the non-reciprocal component in each common optical channel is configured to preserve the polarization direction of the plane-polarized beam as the first propagation-direction-dependent operation, and the non-reciprocal component in each common optical channel is configured to turn the polarization direction of the plane-polarized beam as the second propagation-direction-dependent operation.

4. The optical element of claim 3, wherein the non-reciprocal component in each common optical channel is configured to turn the polarization direction of the plane-polarized beam as the first propagation-direction-dependent operation, and the non-reciprocal component in the common optical channel is configured to preserve the polarization direction of the plane-polarized beam as the second propagation-direction-dependent operation.

5. The optical element of claim 2, wherein the optical element includes one non-reciprocal component in a common optical channel of two optical channels formed by the polarization transformers,
the first polarization transformer includes an input polarizing beam splitter and a output polarizing beam splitter, and the second polarization transformer includes a transceiving polarizing beam splitter and a totally reflecting mirror; and in the transmission direction,
the input polarizing beam splitter is configured to pass a plane-polarized beam into the common optical channel,
the transceiving polarizing beam splitter is configured to transmit the optical beam from the common optical channel through the common aperture, and in the reception direction,
the transceiving polarizing beam splitter is configured to split the optical beam from the common aperture into two orthogonal plane-polarized beams, to pass a plane-polarized beam into the common optical channel and to pass a differently plane-polarized beam to the totally reflecting mirror configured to reflect the differently plane-polarized beam to another optical channel,
the input polarizing beam splitter is configured to reflect the plane-polarized beam to the output polarizing beam splitter, and
the output polarizing beam splitter is configured to combine the plane-polarized beams from the optical channels into a received optical beam for outputting the received optical beam through the exit aperture of the reception direction.

6. The optical element of claim 1, wherein each non-reciprocal component includes a quarter-wave component configured to turn a polarization direction by 45 degrees independently of the propagation direction, and a non-reciprocal rotator configured to turn a polarization direction by 45 degrees depending on the propagation direction.

7. A measuring apparatus, the measuring apparatus configured to transmit an optical beam towards an object in a transmission direction through the optical element, and to receive an optical beam reflected from the object in a reception direction through the optical element, wherein the optical element comprises:
a beam transformer having an entrance aperture of the transmission direction, a common two-directional aperture for an exit in the transmission direction and for an entrance in the reception direction, and an exit aperture of the reception direction, the beam transformer being configured to form at least two internal optical channels supporting different plane-polarization directions, at least one of the internal optical channels being common to the transmission and reception directions,
at least one non-reciprocal component for propagation-direction-dependent polarization operations, and in the transmission direction,
the beam transformer is configured to pass the optical beam from the entrance aperture to at least one common optical channel,
the at least one non-reciprocal component, one in each common optical channel, is configured to perform a first propagation-direction-dependent operation on the optical beam,
the beam transformer is configured to transmit the beam from the at least one common channel through the common aperture; and in the reception direction.
the beam transformer is configured to split the beam received through the common aperture into plane-polarized beams and to pass the plane-polarized beams to the internal optical channels,
each non-reciprocal component is configured to perform a second propagation-direction-dependent operation on the plane-polarized beam in the at least one common optical channel, and
the beam transformer is configured to combine the plane-polarized beams from the internal optical channels into one received optical beam, and to output the received optical beam through the exit aperture of the reception direction different from the entrance aperture of the transmission direction due to propagation-direction-dependent operations in the at least one common optical channel.

8. The measuring apparatus of claim 7, wherein the beam transformer includes a first polarization transformer and a second polarization transformer, and
the first polarization transformer has the entrance aperture of the transmission direction and the exit aperture of the reception direction;
the second polarization transformer has the common two-directional aperture for transmission and reception directions; and in the transmission direction,
the polarization transformers are configured to form the at least two optical channels supporting different plane-polarization directions between the polarization transformers;
the first polarization transformer is configured to pass the optical beam from the entrance aperture into the at least one common optical channel;
the second polarization transformer is configured to transmit the optical beam from the at least one common optical channel through the common aperture; and in the reception direction,
the second polarization transformer is configured to split the optical beam received through the common aperture into plane-polarized beams, and to pass the plane-polarized beams to the at least two optical channels; and
the first polarization transformer is configured to combine the plane-polarized beams from the at least two optical channels into a received beam, and to output the received beam through the exit aperture of the reception direction.

9. The measuring apparatus of claim 7, wherein the non-reciprocal component in each common optical channel is configured to preserve the polarization direction of the plane-polarized beam as the first propagation-direction-dependent operation, and the non-reciprocal component in each common optical channel is configured to turn the polarization direction of the plane-polarized beam as the second propagation-direction-dependent operation.

10. The measuring apparatus of claim 7, wherein the non-reciprocal component in each common optical channel is configured to turn the polarization direction of the plane-polarized beam as the first propagation-direction-dependent operation, and the non-reciprocal component in the common optical channel is configured to preserve the polarization direction of the plane-polarized beam as the second propagation-direction-dependent operation.

11. The measuring apparatus of claim 8, the optical element includes one non-reciprocal component in a common optical channel of two optical channels formed by the polarization transformers,
the first polarization transformer includes an input polarizing beam splitter and a output polarizing beam splitter, and the second polarization transformer includes a transceiving polarizing beam splitter and a totally reflecting mirror; and in the transmission direction,
the input polarizing beam splitter is configured to pass a plane-polarized beam into the common optical channel,
the transceiving polarizing beam splitter is configured to transmit the optical beam from the common optical channel through the common aperture; and in the reception direction,
the transceiving polarizing beam splitter is configured to split the optical beam from the common aperture into two orthogonal plane-polarized beams, to pass a plane-polarized beam into the common optical channel and to pass a differently plane-polarized beam to the totally reflecting mirror configured to reflect the differently plane-polarized beam to another optical channel,
the input polarizing beam splitter is configured to reflect the plane-polarized beam to the output polarizing beam splitter, and
the output polarizing beam splitter is configured to combine the plane-polarized beams from the optical channels into a received optical beam for outputting the received optical beam through the exit aperture of the reception direction.

12. The measuring apparatus of claim 7, wherein the measuring apparatus comprises an optical source and optical fibers, the optical fibers being configured to input an optical beam from the optical source to the optical element in the transmission direction and to receive an optical beam output from the optical element for supplying the optical beam for detection.

13. The measuring apparatus of claim 7, wherein the measuring apparatus comprises a control unit, a start detector and a stop detector which are operationally coupled to the control unit, and the optical source is configured to transmit the optical beam as an optical beam, the control unit is configured to form a start mark at a moment the optical beam departs from the optical element in the transmission direction detected by the start detector, and
form a stop mark at a moment the optical beam arrives in the optical element in the reception direction detected by the stop detector, and
determine a distance corresponding to the difference between the stop mark and the start mark.

14. The measuring apparatus of claim 7, wherein the measuring apparatus is configured to measure a property of a hot-steel processing vessel as a function of the distance determined.

15. The measuring apparatus of claim 7, wherein each non-reciprocal component includes a quarter-wave component configured to turn a polarization direction by 45 degrees independently of the propagation direction, and a non-reciprocal rotator configured to turn a polarization direction by 45 degrees depending on the propagation direction.

16. A measuring method, the method comprising:
transmitting, by a measuring apparatus, an optical beam towards an object in a transmission direction through the optical element;
receiving, by the measuring apparatus, an optical beam reflected from the object in a reception direction through the optical element, and
the transmitting comprising passing, by a beam transformer, the optical beam from an entrance aperture of transmission direction to at least one optical channel common to transmission and reception directions,
performing, by at least one non-reciprocal component, one in each common optical channel, a first propagation-direction-dependent operation on the optical beam,
transmitting, by the beam transformer, the optical beam through a common aperture for the transmission and the reception directions; and
the receiving comprising splitting the beam received through the common aperture into plane-polarized beams, and passing the plane-polarized beams to the internal optical channels by the beam transformer,
performing, by each non-reciprocal component, a second propagation-direction-dependent operation on the plane-polarized beam in the at least one common optical channel,
combining the plane-polarized beams from the internal optical channels into one received beam, and outputting the received beam through the exit aperture of the reception direction by the beam transformer, the exit aperture of the reception direction being different from the entrance aperture of the transmission direction due to propagation-direction-dependent operations in the at least one common optical channel.

17. The measuring method of claim 16, wherein
the beam transformer includes a first polarization transformer, and a second polarization transformer, and
the first polarization transformer has the entrance aperture of the transmission direction and the exit aperture of the reception direction;
the second polarization transformer has the common two-directional aperture for transmission and reception directions; and
the transmitting further comprising, performing passing the optical beam from the entrance aperture into the at least one common optical channel by the first polarization transformer;
performing transmitting the optical beam from the at least one common optical channel through the common aperture by the second polarization transformer; and
the receiving comprising performing splitting the optical beam from the two-directional aperture into plane-polarized beams and passing the plane-polarized beams to the at least two optical channels by the second polarization transformer;
performing combining the plane-polarized beams into a received beam from the at least two optical channels and outputting the received beam through the exit aperture of the reception direction different from the entrance aperture of the transmission direction by the first polarization transformer.

18. The measuring method of claim 16, the method further comprising performing the first propagation-direction-dependent operation by preserving the polarization direction of the plane-polarized beam in each common optical channel, and performing the second propagation-direction-dependent operation by turning the polarization direction of the plane-polarized beam in each common optical channel.

19. The measuring method of claim 16, the method further comprising performing the first propagation-direction-dependent operation by turning the polarization direction of the plane-polarized beam in each common optical channel, and performing the second propagation-direction-dependent operation by preserving the polarization direction of the plane-polarized beam in each common optical channel.

20. The measuring method of claim 16, wherein the optical element includes one non-reciprocal component in a common optical channel of two optical channels between the polarization transformers,
the first polarization transformer includes an input polarizing beam splitter and an output polarizing beam splitter, and the second polarization transformer includes a transceiving polarizing beam splitter and a mirror;
the transmitting further comprising performing passing a plane-polarized beam from the entrance aperture of the transmission direction into the common optical channel by the input polarizing beam splitter,
performing transmitting the optical beam from the common optical channel through the common aperture by the transceiving polarizing beam splitter; and
in the reception direction performing splitting the optical beam from the common aperture into two orthogonally plane-polarized beams, passing a plane-polarized beam into the common optical channel and passing a differently plane-polarized beam to the mirror for reflecting the differently plane-polarized beam to another optical channel by the transceiving polarizing beam splitter;
reflecting the plane-polarized beam to the output polarizing beam splitter by the input polarizing beam splitter, and
performing combining the plane-polarized beams from the optical channels into a received optical beam for outputting the received optical beam through the exit aperture of the reception direction by the output polarizing beam splitter.

21. The measuring method of claim 16, the method further comprising an optical source and optical fibers, the optical fibers being configured to input an optical beam from the optical source to the optical element in the transmission direction and to receive an optical beam output from the optical element for supplying the optical beam for detection.

22. The measuring method of claim 16, the method further comprising transmitting the optical beam as an optical beam by an optical source,
forming a start mark at a moment the optical beam departs from the optical element in the transmission direction detected by the start detector, and
forming a stop mark at a moment the optical beam arrives in the optical element in the reception direction detected by the stop detector, and
determining a distance corresponding to the difference between the stop mark and the start mark by a control unit.

23. The measuring method of claim 16, the method further comprising measuring a property of a hot-steel processing vessel as a function of the distance determined.

24. The measuring method of claim 16, the method further comprising turning, by a quarter-wave component included in each non-reciprocal component, a polarization direction by 45 degrees independently of the propagation direction, and turning, by a non-reciprocal rotator, included in each non-reciprocal component a polarization direction by 45 degrees depending on the propagation direction.
